(19) United States
(12) Patent Application Publication
(10) Pub. No.: US 2016/0133136 A1
(43) Pub. Date: May 12, 2016

(54) METHOD OF REPRESENTING A CARTOGRAPHIC IMAGE IN A GEOLOCATED DISPLAY SYSTEM TAKING INTO ACCOUNT THE ACCURACY OF GEOLOCATION

(71) Applicant: THALES, Courbevoie (FR)

(72) Inventors: Xavier Servantie, Pessac (FR); Emmanuel Monvoisin, Bordeaux (FR); Didier Poisson, Toulouse (FR)

(21) Appl. No.: 14/934,108

(22) Filed: Nov. 5, 2015

(30) Foreign Application Priority Data
Nov. 7, 2014 (FR) 1402531

(51) Int. Cl. G08G 5/00; G01C 23/00; G06T 11/60; G06F 17/30; G06T 15/00

(52) U.S. Cl. CPC G08G 5/0047; G06F 17/30241; G06T 15/00; G06T 11/60; G01C 23/00

(57) ABSTRACT

The general field of the invention is that of methods of representing a cartographic image in a geolocated synthetic vision system for vehicles, said system including a cartographic database, geolocation means, graphic generation means enabling generation of a two-dimensional or three-dimensional synthetic view of said terrain, and a display device. In the method in accordance with the invention, the angular position of each point of the synthetic view is known with an angular error depending on the distance of said vehicle and the accuracy of geolocation of said vehicle, if said angular error is less than or equal to a predetermined angular tolerance, the point is represented in a standard representation mode and if said angular error is greater than a predetermined angular tolerance, the point is represented in an uncertainty representation mode different from the standard representation mode. The applications are preferably aeronautical.

The field of the invention is that of display systems including means for displaying a synthetic image of the outside view. The invention applies very particularly to the aeronautical field but may be applied to any vehicle including means for displaying such a synthetic image.

Modern aircraft generally have a synthetic vision system (SVS). This system enables presentation to the crew of a synthetic image of the outside view generally including piloting or navigation information. An SVS system includes a cartographic database representative of the overflown terrain, a geolocation system, electronic computation means, and one or more display devices installed in the cockpit of the aircraft. The geolocation system is of the global positioning system (GPS) type. It may be coupled to the inertial system of the machine. The geolocation system as a whole supplies at least the following parameters: position of the aircraft in terms of latitude, longitude and altitude and orientation of the aircraft in terms of pitch, roll and bearing and finally, accuracy of the location.

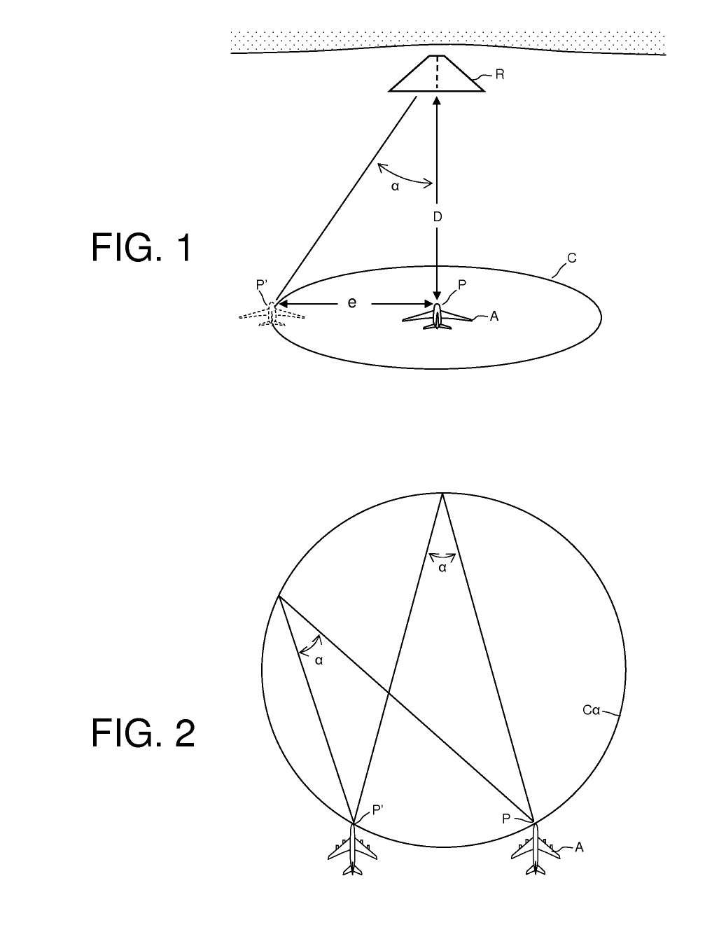

The image displayed is generally a three-dimensional view of the outside represented in the most realistic possible manner. This image is very attractive for the crew in that it provides them with a view of their environment that is close to reality and in particular a view of certain elements that are fundamental for navigation such as landing strips. One of the disadvantages of this representation is that the accuracy of the positioning of the important elements depends, of course, on the accuracy of the location of the machine. The inaccuracy in respect of the position of the machine distorts the three-dimensional image relative to reality in a manner that is more pronounced according to the closeness of the information to the aircraft. A positioning error of a few tens of metres therefore has a very strong impact on elements a few hundred metres from the machine whereas the information presented at several kilometres is only very slightly impacted. The image presented can therefore prove relatively inaccurate. FIG. 1 illustrates this problem. It represents a perspective view of an aircraft A on the approach to a landing strip R. The strip s is at a mean distance D from the aircraft. The aircraft A occupies the position P. However, this position P is known with an uncertainty e. The computed position P′ of the aircraft can therefore be anywhere in a circle of radius e centred on the position P. The angular error a between the real position of the strip and its simulated position is therefore, to a first approximation:

α=e/D Equation 1

Note that in this figure and the next figure, for reasons of clarity, the angles a are intentionally exaggerated.

The method in accordance with the invention enables this error to be taken into account in the display of the cartographic information. As has been stated, and as can be seen in equation 1, the angular error a decreases with the distance. Now, below a certain tolerance value, the angular error becomes negligible or cannot give rise to significant assessment errors. The cartographic representation method in accordance with the invention starts from this observation. It consists in representing faithfully only sure information, i.e. information below the angular tolerance threshold. To be more precise, the invention consists in a method of representing a cartographic image in a geolocated synthetic vision system for vehicles, said system including at least one cartographic database representative of the terrain travelled by the vehicle, means for geolocation of said vehicle, graphic generation means enabling generation of a three-dimensional synthetic view of said terrain, and a display device,

characterized in that, the position of the vehicle being known with a particular accuracy the angular position of each point of the synthetic view being known with an angular error depending on the distance of said point from said vehicle and the accuracy of the position of said vehicle, if said angular error is less than or equal to a predetermined angular tolerance, the point is represented in a standard representation mode and if said angular error is greater than a predetermined angular tolerance, the point is represented in an uncertainty representation mode different from the standard representation mode.

Points represented in the uncertainty representation mode are advantageously all of a uniform colour.

Each first point represented in the uncertainty representation mode advantageously has a colour different from that of an equivalent second point representing the same type of object as the first point and represented in the standard representation mode.

Points represented in the uncertainty representation mode are advantageously fuzzy.

The display device being adapted to form the synthetic view superimposed on the terrain, points represented in the uncertainty representation mode are advantageously represented semi-transparently on said terrain.

Points represented in the uncertainty representation mode are advantageously represented under a semi-transparent background, the transparency being a function of the angular error, if the angular error is less than or equal to the predetermined angular tolerance, the transparency of the background is total and if the angular error is greater than the predetermined angular tolerance, the transparency decreases as far as total opacity as a function of the increase in the angular error, the points represented no longer being visible.

If the synthetic vision system includes an image sensor, points represented in the uncertainty representation mode are advantageously replaced by points of an image from an image sensor representative of the same terrain.

The invention also consists in a geolocated synthetic vision system for vehicles, including at least one cartographic database representative of the terrain travelled by the vehicle, means for geolocation of said vehicle, graphic generation means enabling generation of a three-dimensional synthetic view of said terrain, and a display device,

characterized in that:

the geolocation means compute the position of the vehicle with a particular accuracy,

the graphic generation means
compute the angular position of each point of the synthetic view with an angular error depending on the distance of said point from said vehicle and the accuracy of the position of said vehicle, and
if said angular error is less than or equal to a predetermined angular tolerance, represent the point in a standard representation mode and if said angular error is greater than a predetermined angular tolerance, represent the point in an uncertainty representation mode different from the standard representation mode.

The vehicle is advantageously an aircraft.

The invention will be better understood and other advantages will become apparent on reading the following description given by way of nonlimiting example and thanks to the appended figures, in which:

FIG. 1, already commented on, represents a perspective view of an aircraft on approach;

FIG. 2 represents an example of the loci of constant angular uncertainty points;

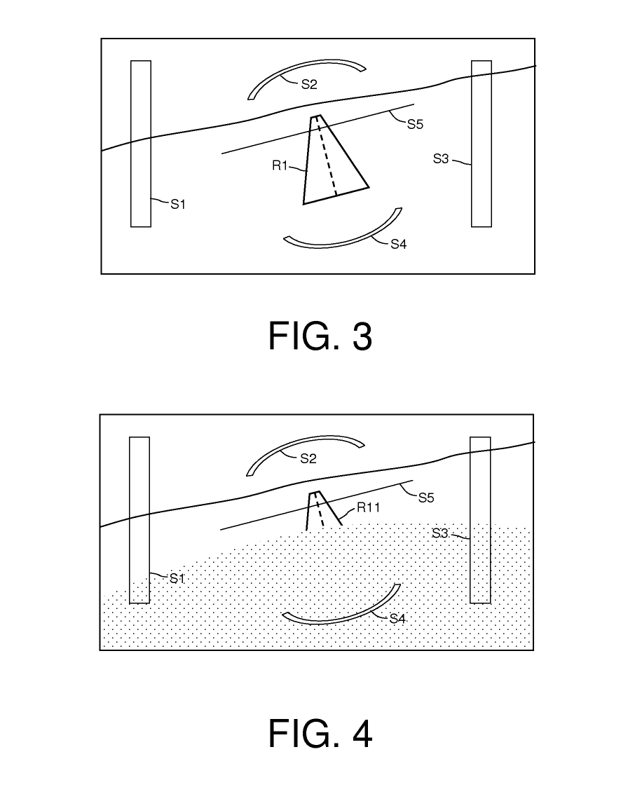

FIG. 3 is a simplified representation of a prior art synthetic view;

FIGS. 4 to 7 represent different variants in accordance with the invention of the preceding simplified representation of a synthetic view.

The method in accordance with the invention of representing a cartographic image in a geolocated synthetic vision system can be applied to all types of vehicle having a geolocation system and a cartographic database. It is however particularly suitable for aircraft in that the accuracy of the display of cartographic data is fundamental for this type of vehicle.

The synthetic vision system or SVS in accordance with the invention installed on board an aircraft includes at least one cartographic database, geolocation means, a graphic computer and at least one display device. The geolocation means are, for example, of the GPS (Global Positioning System) type optionally coupled to or combined with inertial centres in a hybrid system.

In modern aircraft, the system generally includes a plurality of display devices disposed in the cockpit displaying parameters necessary for piloting and navigation and more generally for accomplishing the mission. These display devices can represent the information either without superimposition on the outside view or superimposed on the outside view by means of a semi-transparent “combiner” or a screen that allows the view to be seen through it. There are various ways to represent the overflown terrain. It is generally represented by a three-dimensional cartographic view. These views generally include navigation data.

When the data represented in superimposed on the outside, the overflown terrain is generally represented in a three-dimensional conforming view, meaning that the synthetic objects represented are displayed at the exact location of the real objects that they represent. For example, a synthetic strip is represented, from the point of view of the user, at the exact location of the real strip that it represents.

As has been stated, the position of the aircraft being known with a particular accuracy, the angular position of each point of the view is known with an angular uncertainty a the value of which is determined by equation 1. It is then possible to determine the locus of points having an angular uncertainty equal to or greater than a particular threshold. For example, FIG. 2 represents the locus Cα of these points in a horizontal section plane. This is a circle of diameter φ equal to e/tan(α). If the angular uncertainty a represents the angular tolerance that is acceptable for the point to be represented with a sufficiently low margin of uncertainty to be representative of the real position, then all the points outside the circle can without difficulty be represented in a mode of representation that will be referred to here as the standard mode. All the points inside the circle have too high a position uncertainty. In this case, the method in accordance with the invention represents them differently to alert the user to the fact that these points represent a difficulty. The angular tolerance required is generally low, of the order of a few milliradians. On a high-resolution display screen it corresponds to a few pixels at most.

By way of nonlimiting example, FIG. 3 represents a simplified view of a prior art synthetic view and FIGS. 4 to 7 represent different variants in accordance with the invention of the same simplified view in a display device including a semi-transparent combiner or a screen.

This simplified view includes symbols and information S1, S2, S3, S4 and S5 concerning piloting or navigation. This information conventionally concerns the altitude, speed or attitude of the machine. It also includes the representation of a synthetic strip R1 that appears in the form of an inclined trapezium. In accordance with the prior art represented in FIG. 3, this strip consists of uniform bold lines.

It is assumed that a first part R11 of this strip is at a distance such that this first part is below the angular tolerance threshold and a second part R12 of this strip is at a distance such that this second part is above the angular tolerance threshold. In this case, the first part is represented in the standard representation mode and the second part is represented differently.

There are different variants in terms of the representation of this second part. In a first embodiment shown in FIG. 4, points represented in the uncertainty representation mode are all of a uniform colour. In this case, the second part disappears. Only the first part R11 appears.

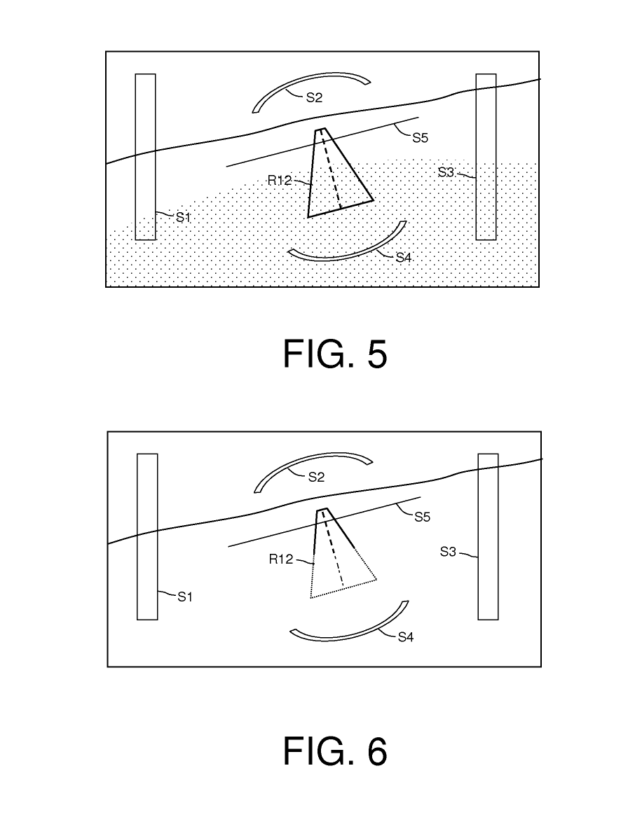

In a second embodiment shown in FIG. 5, points represented in the uncertainty representation mode are all of a semi-transparent colour. In this case, the second part R12 appears in this semi-transparent area.

In a third embodiment shown in FIG. 6, the second part R12 is represented with semi-transparent lines or different colour lines. In a variant of this representation mode, the points are represented under a semi-transparent background, the transparency being a function of the angular error. If the angular error is less than or equal to the predetermined angular tolerance, the transparency of the background is total and it does not appear. If the angular error is greater than the predetermined angular tolerance, the transparency decreases as far as total opacity as a function of the increase in the angular error, the points represented then no longer being visible.

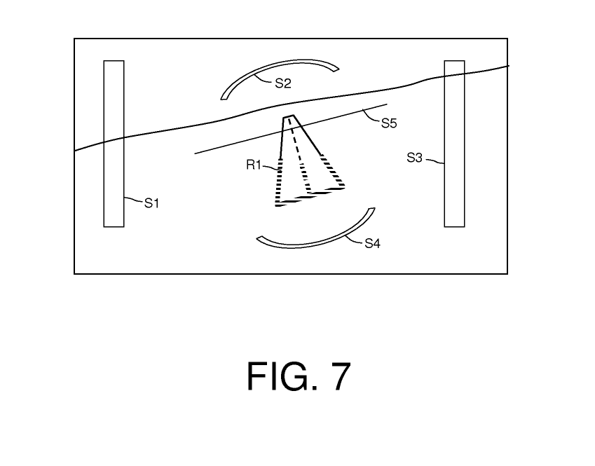

In a fourth representation mode shown in FIG. 7, the second part R12 is represented in fuzzy lines.

Of course, it is possible to combine these various representation effects. The criterion is that the user must perceive unambiguously, i.e. with sufficient contrast, that the area represented is above or below the tolerance threshold.

Finally, in a final variant, the area of the points situated above the angular tolerance threshold is replaced by an image from an image sensor representative of the same terrain. This sensor may be a low light level image sensor or an infrared video camera.

1. A method of representing a cartographic image in a geolocated synthetic vision system for vehicles, said system comprising at least one cartographic database representative of the terrain travelled by the vehicle, means for geolocation of said vehicle, graphic generation means enabling generation of a three-dimensional synthetic view of said terrain, and a display device,
wherein, the position of the vehicle being known with a particular accuracy the angular position of each point of the synthetic view being known with an angular error depending on the distance of said point from said vehicle and the accuracy of the position of said vehicle, if said angular error is less than or equal to a predetermined angular tolerance, the point is represented in a standard representation mode and if said angular error is greater than a predetermined angular tolerance, the point is represented in an uncertainty representation mode different from the standard representation mode.

2. The representation method according to claim 1, wherein the point represented in the uncertainty representation mode are all of a uniform colour.

3. The representation method according to claim 1, wherein each first point represented in the uncertainty representation mode has a colour different from that of an equivalent second point representing the same type of object as the first point and represented in the standard representation mode.

4. The representation method according to claim 1, wherein points represented in the uncertainty representation mode are fuzzy.

5. The representation method according to claim 1, wherein the display device being adapted to form the synthetic view superimposed on the terrain, points represented in the uncertainty representation mode are represented semi-transparently on said terrain.

6. The representation method according to claim 1, wherein points represented in the uncertainty representation mode are represented under a semi-transparent background, the transparency being a function of the angular error, if the angular error is less than or equal to the predetermined angular tolerance, the transparency of the background is total and if the angular error is greater than the predetermined angular tolerance, the transparency decreases as far as total opacity as a function of the increase in the angular error, the points represented no longer being visible.

7. The representation method according to claim 1, wherein if the synthetic vision system includes an image sensor, points represented in the uncertainty representation mode are replaced by points of an image from an image sensor representative of the same terrain.

8. A geolocated synthetic vision system for vehicles, comprising at least one cartographic database representative of the terrain travelled by the vehicle, means for geolocation of said vehicle, graphic generation means enabling generation of a two-dimensional or three-dimensional synthetic view of said terrain, and a display device,
wherein:
the geolocation means compute the position of the vehicle with a particular accuracy,
the graphic generation means
compute the angular position of each point of the synthetic view with an angular error depending on the distance of said point from said vehicle and the accuracy of the position of said vehicle, and
if said angular error is less than or equal to a predetermined angular tolerance, represent the point in a standard representation mode and if said angular error is greater than a predetermined angular tolerance, represent the point in an uncertainty representation mode different from the standard representation mode.

9. The geolocated synthetic vision system according to claim 8, wherein the vehicle is an aircraft.
